(19) United States
(12) Patent Application Publication
(10) Pub. No.: US 2025/0077287 A1
(43) Pub. Date: Mar. 6, 2025

(54) RESOURCE ALLOCATION TO AVOID COMMAND TIMEOUTS IN A STORAGE DEVICE

(71) Applicant: Western Digital Technologies, Inc., San Jose, CA (US)

(72) Inventors: Amir SEGEV, Meiter (IL); Shay BENISTY, Beer Sheva (IL)

(73) Assignee: Western Digital Technologies, Inc., San Jose, CA (US)

(21) Appl. No.: 18/461,939

(22) Filed: Sep. 6, 2023

(51) Int. Cl. G06F 9/50

(52) U.S. Cl. CPC G06F 9/5027

(57) ABSTRACT

Instead of handling resources with one generic method, the controller can use a static method or dynamic method to handle the resources. The controller communicates to the host as to the number of resources the controller has for keeping doorbell times. The controller will also communicate with the host how those resources are used. The static method focuses on creating dedicated submission queues (SQ), while the dynamic method provides a hint during the doorbell execution. The static method further focuses on improving priority, while the dynamic method focuses on canceling commands that have timed out. The static method and the dynamic method can be combined to further support the hosts requirements.

### BACKGROUND OF THE DISCLOSURE

### Field of the Disclosure

Embodiments of the present disclosure generally relate to improving command timing management.

### Description of the Related Art

When timing requirements are not met for input/output (I/O) commands, issues arise. When a controller tries to service a command after the command times out, the controller has decreased performance. If the service is requested and is not able to complete the request, then the system decides to not service the command at all. Since there are currently no time limits set for I/O commands, there is a lack of organization of command execution. Through the lack of command organizations, commands are timed out without services that were requested.

Non-Volatile Memory express (NVMe) would benefit from providing a mechanism for the host to set time limits for I/O commands that access the media. This allows the host to prioritize some commands over others based on their timing requirements. The controller is then left to perform actions based on the requirements. These actions are useful to the host if the timing requirements are not met.

Therefore, there is a need in the art for improving command timing management.

### SUMMARY OF THE DISCLOSURE

Instead of handling resources with one generic method, the controller can use a static method or dynamic method to handle the resources. The controller communicates to the host as to the number of resources the controller has for keeping doorbell times. The controller will also communicate with the host how those resources are used. The static method focuses on creating dedicated submission queues (SQ), while the dynamic method provides a hint during the doorbell execution. The static method further focuses on improving priority, while the dynamic method focuses on canceling commands that have timed out. The static method and the dynamic method can be combined to further support the host's requirements.

In one embodiment, a data storage device comprises: a memory device; and a controller coupled to the memory device, wherein the controller is configured to: communicate with a host device to inform the host device of a number of resources available for keeping doorbell times; handle the resources in a static manner, a dynamic manner, or a combination of static and dynamic, wherein the static manner is a dedicated submission queue (SQ), the dynamic manner is a hint during the doorbell.

In another embodiment, a data storage device comprises: a memory device; and a controller coupled to the memory device, wherein the controller is configured to: receive a submission queue creation command; determine whether the submission queue is a high priority submission queue or a low timing submissions queue; determine whether a size of the submission queue is greater than a size of a static doorbell timing resource counter; mark the submission queue as low timing and high priority; decrease the static doorbell timing resource counter; and create the submission queue and send a completion message.

In another embodiment, a data storage device comprises: means to store data; and a controller coupled to the means to store data, wherein the controller is configured to: compute a timeout of commands, wherein the computing comprises determining whether a command's timestamp plus a defined system timeout is greater than a current time; and timing out the command.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a block diagram illustrating a system for bandwidth requirements, according to one embodiment.

FIG. 3 is a block diagram illustrating a system for an execution order, according to one embodiment.

FIG. 4 is a diagram illustrating a system for doorbell organization based on doorbell stride, according to one embodiment.

FIG. 5 is a diagram illustrating a system for submission queue prioritization, according to one embodiment.

FIG. 6 is a flowchart illustrating a method for max doorbell timing resources (MDBTR), according to certain embodiments.

FIG. 7A is a flowchart illustrating a method for SQ creation, according to certain embodiments.

FIG. 7B is a flowchart illustrating a method for doorbell arrival, according to certain embodiments.

FIG. 7C is a flowchart illustrating a method for command fetched, according to certain embodiments.

FIG. 7D is a flowchart illustrating a method for a command reaches firmware (FW), according to certain embodiments.

FIG. 7E is a flowchart illustrating a method for a completion is sent, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Instead of handling resources with one generic method, the controller can use a static method or dynamic method to handle the resources. The controller communicates to the host as to the number of resources the controller has for keeping doorbell times. The controller will also communicate with the host how those resources are used. The static method focuses on creating dedicated submission queues (SQ), while the dynamic method provides a hint during the doorbell execution. The static method further focuses on improving priority, while the dynamic method focuses on canceling commands that have timed out. The static method and the dynamic method can be combined to further support the hosts requirements.

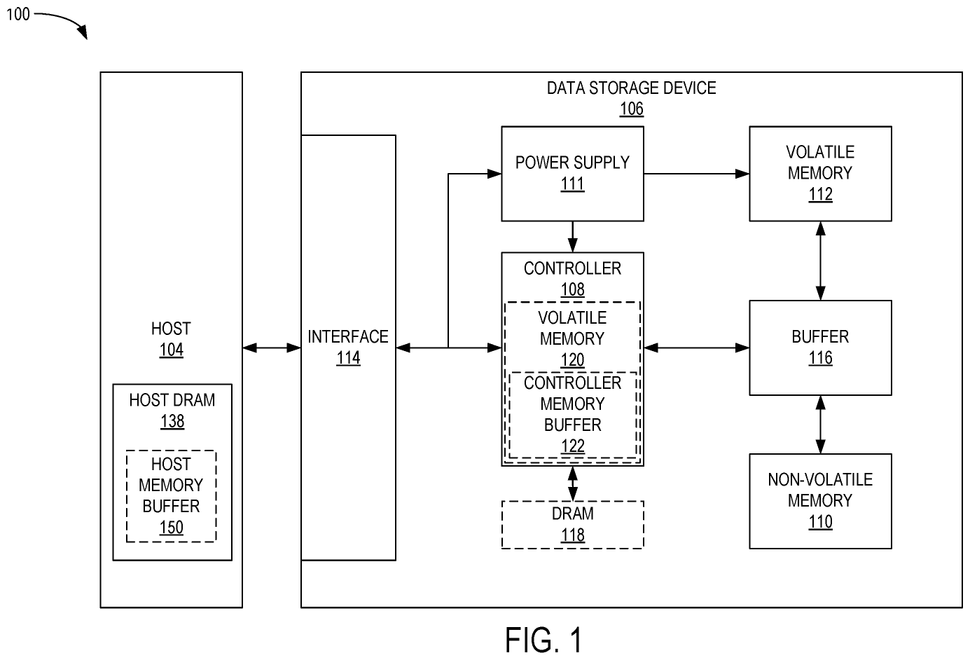

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

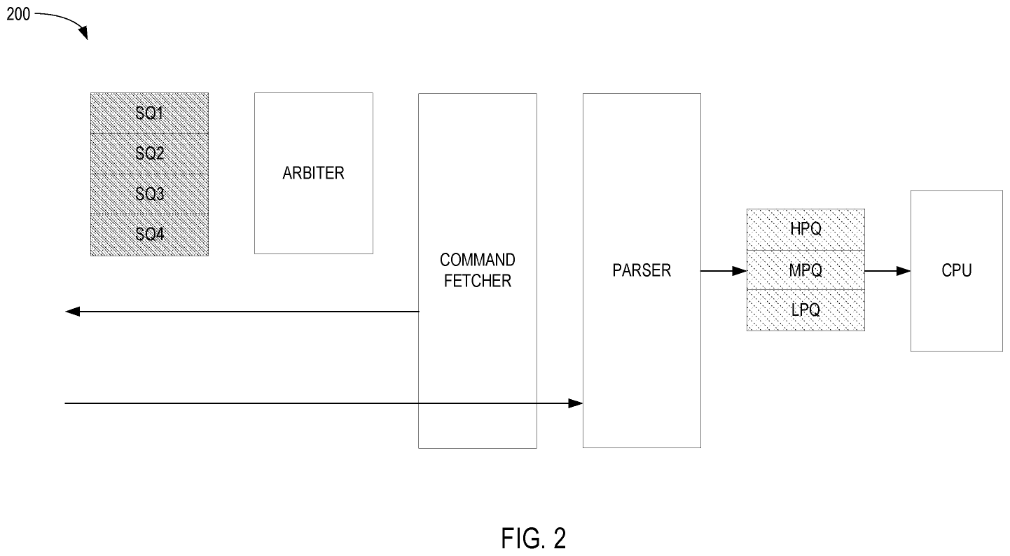

FIG. 2 is a block diagram illustrating a system 200 for bandwidth requirements, according to one embodiment. System 200 shows how commands are fetched, parsed, and classified. After the host performs a doorbell, the system 200 performs arbitration on a selected SQ (SQ1, SQ2, SQ3, and SQ4) by the arbiter. The arbiter decides from which queue to fetch commands. Once a decision is made, a command fetcher performs a read of the command. When the command arrives, the parser checks for any violation in the arriving command, and attaches device side attributes to help the device firmware (FW) make better/faster decisions on the execution phase.

The fetched commands then enter a queuing mechanism, which might include a high priority queue (HPQ), a medium priority queue (MPQ), and low priority queue (LPQ) for normal commands. There might be a queue for multiple priorities. Later, as commands reach the CPU (i.e., FW), the commands can be marked with a “too-late” indication if the timing requirement has passed. If the timing requirement has passed the FW can decide to complete the command without executing it.

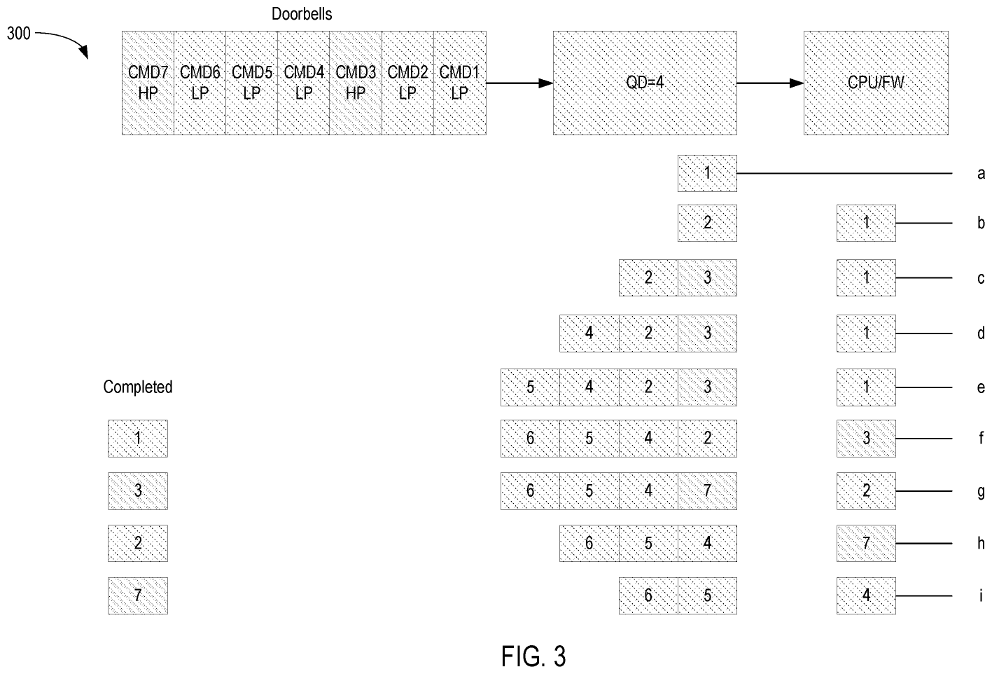

FIG. 3 is a block diagram illustrating a system 300 for an execution order, according to one embodiment. System 300 shows a device with a queue depth of four commands. The host issues doorbells for seven commands. Command 3 and command 7 are either high priority (HP) or low timeout while the rest are low priority (LP) or high timeout. At step ‘a’ the fetcher fetches (into the queue) the first command (CMD1). At step ‘b’ the CPU starts to work on CMD1, and the fetcher fetches CMD2. At step ‘c’ the CPU still works on CMD1, and the fetcher fetches CMD3. The parser detects the CMD3 is HP and the queue is re-ordered accordingly. At step ‘d’ the CPU still works on CMD1 while CMD4 is fetched. At step ‘e’ the CPU still works on CMD1 while CMD5 is fetched. After a time, while the queue is full (when CPU finishes CMD1) at step ‘f’ a CMD1 completion is sent to the host. The CPU starts on CMD3 while CMD6 is fetched. After a time, while the queue is full (when CPU finishes CMD3) at step ‘g’ CMD3 completed. The CPU starts on CMD2 while CMD7 is fetched and goes to the head of queue due to HP. After a time, while the queue is full (when CPU finishes CMD2) at step ‘h’ CMD2 is completed. The CPU starts on CMD7. After a time, while the queue is full (when CPU finishes CMD7) at step ‘I’ CMD7 is completed. The CPU starts on CMD4. Command 7 (HP) finishes as the fourth command, instead of second command. Arriving as the fourth command takes longer than the second command, possibly arriving too late to the completion phase. As the time the host measured for command completion is from the doorbell, and not from when the command is fetched, the desired order of completion from the host perspective is CMD1, CMD3, CMD7, CMD2, CMD4, CMD5, and CMD6.

In another embodiment, possibly CMD7 has been timed out already, and a “timeout” error completion should have been sent to the host. However, typically the device can start counting the time from when the command was fetched.

When the system 300 works with a small number of SQs, and short SQs (i.e., 8 queues, each of 8 commands, like in HDD devices) the device can track the actual 64 doorbells and attach the doorbell timing as commands are fetched. When there is a large number of queues, such as 512 SQs when each submission-queue (in theory) can reach up to 16K commands, holding that many “timestamps” is impossible. As will be discussed herein, the disclosure allows a way for the host to prioritize specific commands for fetching and a way to track commands timestamps based upon doorbells.

There are two parts discussed herein. In the first part, the controller communicates to the host as to the number of resources that the controller has for keeping doorbell times. The second part deals with how those resources are used. The disclosure suggests two ways to handle the resources: a static way and a dynamic way. The static way creates dedicated SQs while the dynamic way provides a hint during the doorbell. The static way focuses on improving priority while the dynamic way is focused more on cancelling commands that have timed out. The static and dynamic ways can be combined to better fit the host requirements and enjoy both benefits.

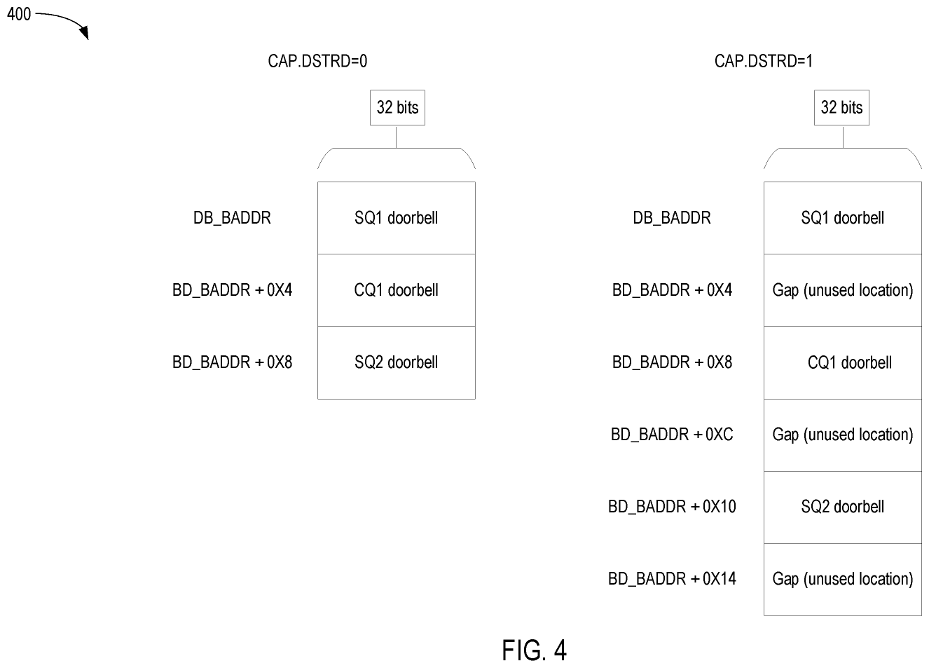

FIG. 4 is a diagram illustrating a system 400 for doorbell organization based on doorbell stride, according to one embodiment. To use dynamic resources, the host uses the doorbell stride option. The doorbell stride option provides “extra” space per doorbell register. The system 400 uses the default doorbell scheme (CAP.DSTRD=0), which means that the doorbells are packed back-to-back. Whereas for CAP.DSTRD=1 there is a DWORD (4 bytes) gap between each two doorbells.

The use of dynamic doorbell timing resources (DDBTR) allows the host to submit up to a known number of doorbells into the “gaps”. When a doorbell is written to a gap, the controller marks, and stores the time of the doorbell. Each mark utilizes one resource. This method is considered dynamic, as the host does not need to allocate the resource to a specific SQ in advance. The host can decide to use resources just-in-time.

Ideally, the host will insert high priority commands into the gaps so that the high priority commands can be executed prior to a timeout. If there are no high priority commands to place into a gap, then no commands will be placed into the gap. When the controller fetches from the SQ and encounters an empty gap, the controller simply fetches the next command after the gap. FIG. 4 shows an example of a setup for a dynamic situation. DB_BADDR has the SQ1 doorbell, then BD_BADDR+0X4 is a gap that may or may not be used for high priority commands and is treated as a write to SQ1. BD_BADDR+0X8 is for CQ1 doorbell. BD_BADDR+0XC is another gap that may or may not be used for high priority commands. BD_BADDR+0X10 contains the SQ2 doorbell. BD_BADDR+0X14 is a gap that may or may not be used for high priority commands. Thus, in one embodiment, a gap may be present between each doorbell. It is to be understood that the gaps may be disposed at different locations if desired such as between every 2 doorbells.

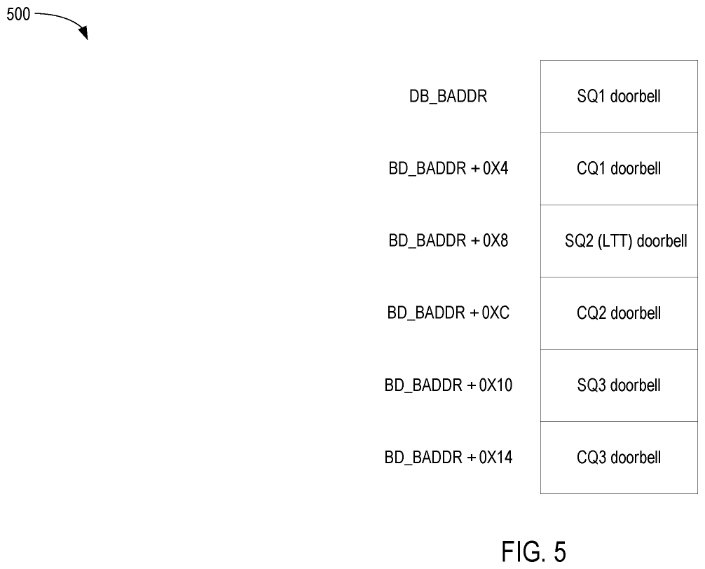

FIG. 5 is a diagram illustrating a system 500 for submission queue prioritization, according to one embodiment. The host is using SQ2 as a “low timeout” queue. A “low timeout” queue is a queue whose command has a strict timeout. The timing to any doorbell in SQ2 will be logged.

The host can use static doorbell timing resources (SDBTR) to size up the “low timeout” queue, or rather all “low timeout” queues. This method is considered static as the host needs to decide in advance the number of resources that need to be allocated per low timeout queue.

Ideally, the host will insert high priority commands into SQ2 so that the high priority commands can be executed prior to a timeout. FIG. 5 shows an example of a setup for a static situation. DB_BADDR has the SQ1 doorbell, then BD_BADDR+0X4 has the completion queue (CQ) 1 doorbell. BD_BADDR+0X8 is for the high priority queue (i.e., SQ2) doorbell. BD_BADDR+0XC for CQ2 doorbell. BD_BADDR+0X10 contains the SQ3 doorbell. BD_BADDR+0X14 is contains the CQ3 doorbell.

The static approach can further allow defining the ‘low timeout’ as a high priority queue so that the controller may fetch and execute the commands faster. However, in static mode, there is no ordering resemblance between normal and low timeout queues. FUSE or back to back commands cannot be shared across queues. In the dynamic approach, the allocation of resources can be done at run time, however, that does not provide priority to the commands, only a way to measure the timeout. Additionally, the static approach involves using more SQs and the dynamic approach involves maintaining a counter of doorbell timing resources available for use. A combined approach allows the host to split the max doorbell timing resources (MDBTR) between the two methods such that MDBTR=SDBTR+DDBTR.

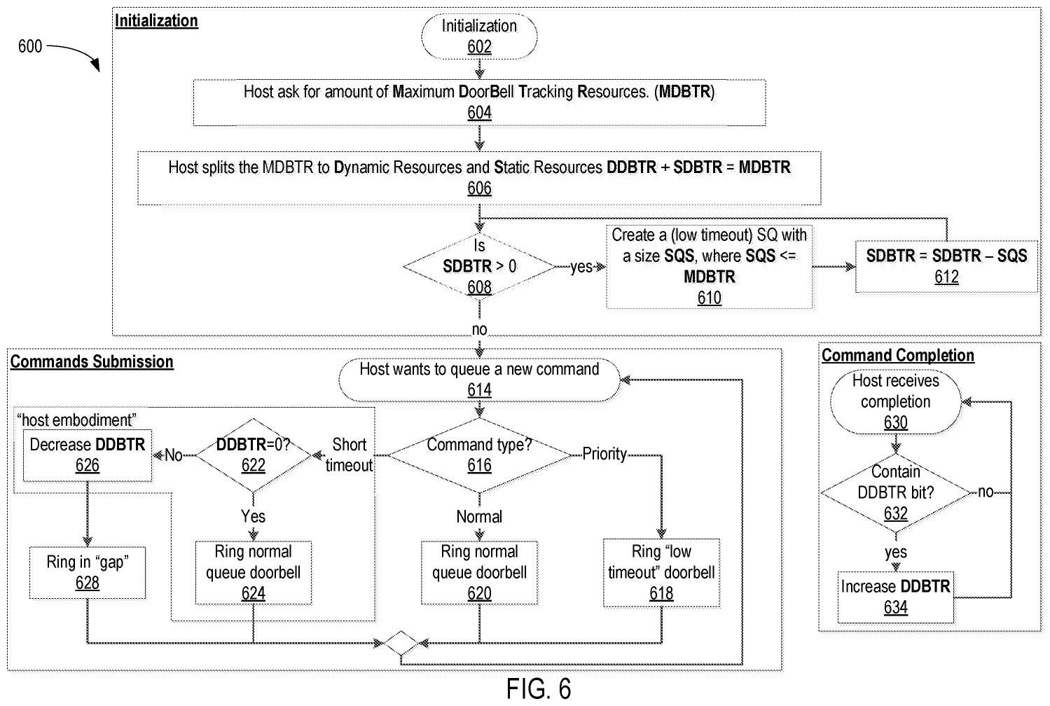

FIG. 6 is a flowchart illustrating a method 600 for MDBTR, according to certain embodiments. There are three sub-flows which are initialization, command submission, and command completion. During the initialization sub flow, the host requests for the number of doorbell timing resources. The resources can be split between dynamic and static, and use the static to create dedicated SQs of higher priority. During the submission sub flow, the host decides based on requirements where and how to queue the command to. The host first checks if the command is a normal command (no special time-out consideration applies). If that is the case, the controller will queue the command normally. If the command is of HP and short timeout, then the controller will queue the command to the HP low-timeout queue. If the command is a short-timeout and not of HP, then the controller will queue the command using the gap after the doorbell. The host can track the number of free dynamic resources to make a decision to send the short-timeout command to the normal queue (or even wait for free resource). During the completion sub flow, when getting a completion, the host will know that a resource has been freed based upon a bit in the completion structure.

The method 600 begins at block 602 with initialization. At block 604, the host asks for the amount of maximum doorbell tracking resources (MDBTR). At block 606, the host splits the MDBTR to dynamic resources and static resources (DDBTR+SDBTR=MDBTR). At block 608, the controller determines if SDBTR is greater than zero. If the controller determines that the SDBTR is greater than zero, then the method 600 proceeds block 610. At block 610, the controller creates a (low timeout) SQ with a size SQS, where SQS<=MDBTR. At block 612, SDBTR=SDBTR-SQS and returns to block 608. If the controller determines that the SDBTR is not greater than zero, then the method 600 proceeds block 614. The commands submission sub flow begins at block 614. At block 614, the host wants to queue a new command. At block 616, the controller determines whether the command type is either priority, normal, or short timeout. If the controller determines the command to be a priority command, then the method 600 proceeds to block 618. At block 618, ring “low timeout” doorbell. If the controller determines that the command is a normal command, then the method 600 proceeds to block 620. At block 620, ring normal queue doorbell. If the controller determines that the command is a short timeout command, then the method 600 proceeds to block 622. At block 622, the controller determines whether DDBTR equals zero. If the controller determines that DDBTR equals zero, then the method 600 proceeds to block 624 and rings the normal queue doorbell. If the controller determines that DDBTR does not equal zero, then the method 600 proceeds to block 626. At block 626, the controller decreases DDBTR. At block 628, the controller rings in “gap”. At the completion of block 618, 620, 624, and 628, the method 600 returns to block 614. The command completion sub flow begins at block 630. At block 630, the host receives completions. At block 632, the controller determines whether the completions contains a DDBTR bit. If the controller determines that the completion does not contain a DDBTR bit, then the method 600 returns to block 630. If the controller determines that the completion does contain a DDBTR bit, then the method 600 proceeds to block 634. At block 634, the controller increases the DDBTR and returns to block 630.

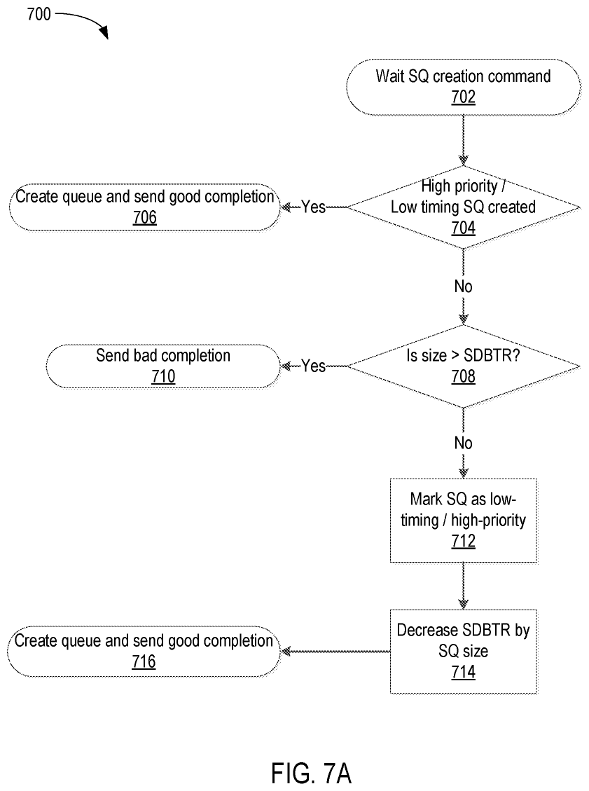

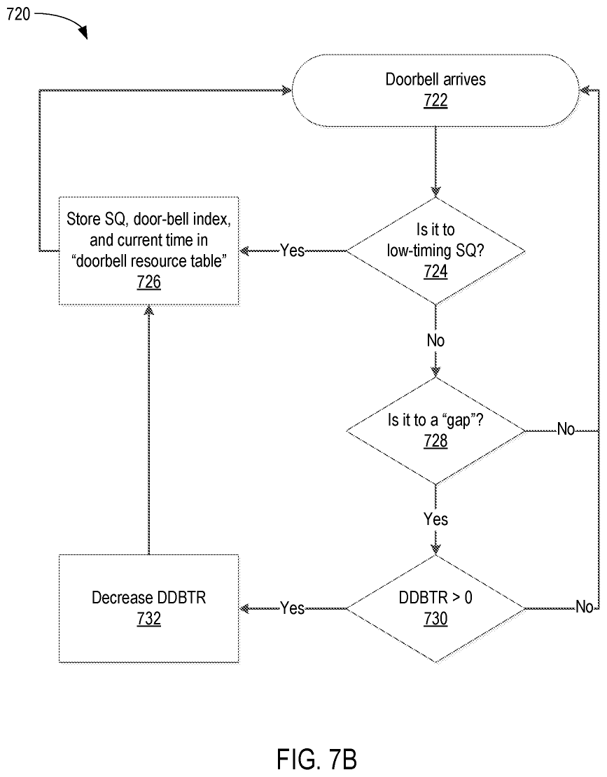

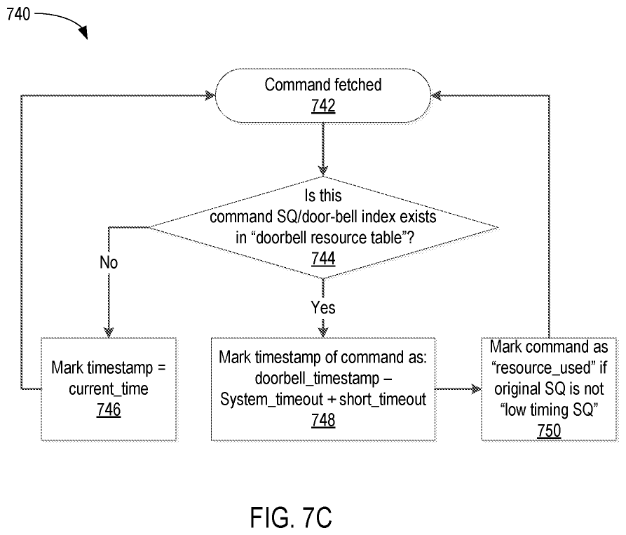

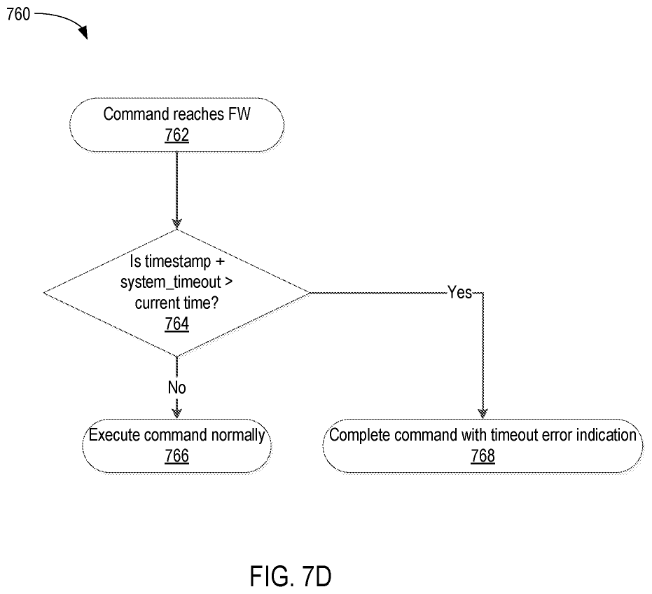

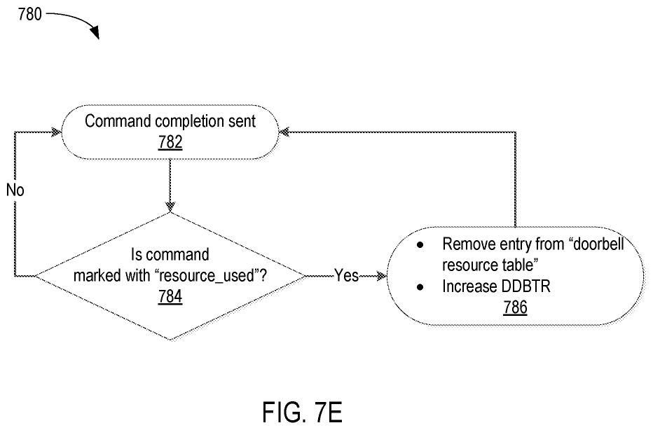

FIG. 7A is a flowchart illustrating a method 700 for SQ creation, according to certain embodiments. When creating a low-timeout/HP queue, the FW checks if there are enough resources. If there are enough resources, then the queue is created and the number of resources is updated.

The method 700 begins at block 702. At block 702, the controller waits for SQ creation command. At block 704, the controller determines whether a HP/low timing SQ is created. If a HP SQ is created, then the method 700 proceeds to block 706. At block 706, the controller creates queue and sends good completion. If a HP SQ is not created, then the method 700 proceeds to block 708. At block 708, the controller determines whether the queue size is greater than SDBTR. If the controller determines that the queue size is greater than SDBTR, then the method 700 proceeds to block 710 and sends a bad completion and does not create the SQ. If the controller determines that the queue size is less than SDBTR, then the method 700 proceeds to block 712. At block 712, the controller marks SQ as low timing/HP. At block 714, the controller decrease SDBTR by SQ size. At block 716, the controller creates queue and sends a good completion.

FIG. 7B is a flowchart illustrating a method 720 for doorbell arrival, according to certain embodiments. When receiving a low timeout doorbell to a dedicated queue, the SQ and the location in the SQ are recorded together with the current time in the “doorbell resource table”. This is also the case when the doorbell arrives to a “gap” and there are enough dynamic resources. If the latter case, the number of dynamic resources decreases.

The method 720 begins at block 722. At block 722, a doorbell arrives and then the method 720 proceeds to block 724. At block 724, the controller determines whether the doorbell is for a low-timing SQ. If the controller determines that the doorbell is for a low-timing SQ, then the method 720 proceeds to block 726. At block 726, the controller stores SQ, doorbell index, and current time in “doorbell resource table”. The doorbell index is tracked with time. If the controller determines that the doorbell is not a low-timing SQ, then the method 720 proceeds to block 728. At block 728, the controller determines whether the doorbell is for a “gap”. If the controller determines that the doorbell is not for a “gap”, then the method 720 returns to block 722. If the controller determines that the doorbell is for a gap, then the method 720 proceeds to block 730. At block 730, the controller determines whether DDBTR is greater than zero. If the controller determines that the DDBTR is not greater than zero, then the method 720 returns to block 722. If the controller determines that the DDBTR is greater than zero, then the method 720 proceeds to block 732. At block 732, the controller decreases DDBTR and the method 720 returns to block 726.

FIG. 7C is a flowchart illustrating a method 740 for a command fetched, according to certain embodiments. When a command is fetched, if the SQ and SQ location matches, then two things happen. The command is marked as “resource used” and the time stamp of the command is manipulated. If there is no such match, the marked time stamp is the current time (of the fetching).

The method 740 begins at block 742. At block 742, the controller fetches a command. At block 744, the controller determines whether the command SQ/doorbell index exists in the “doorbell resource table”. If the controller determines that the command SQ/doorbell index does not exist in the “doorbell resource table”, then the method 740 proceeds to block 746. At block 746, the controller marks timestamp equal to current time (i.e., the time the command was fetched) and then returns to block 742. If the controller determines that the command SQ/doorbell index does exist in the “doorbell resource table”, then the method 740 proceeds to block 748. At block 748, the controller marks timestamp of the command as doorbell timestamp minus system timeout plus short timeout, which is based upon when the doorbell happened. At block 750, the controller marks the command as “resource_used” if original SQ is not “low timing SQ”.

FIG. 7D is a flowchart illustrating a method 760 for when a command reaches FW, according to certain embodiments. If the command's timestamp plus the system normal timeout is bigger than current time (meaning the command execution time has passed), then the command does not get executed. Also, a “failed completion” is sent to the host, otherwise the command is executed normally.

The method 760 begins at block 762. At block 762, a command reaches FW. At block 764, the controller determines whether the timestamp plus system timeout is greater than current time. If the controller determines that the timestamp plus system timeout is not greater than current time, then the method 760 proceeds to block 766. At block 766, the controller executes the command normally. If the controller determines that the timestamp plus system timeout is greater than current time, then the method 760 proceeds to block 768. At block 768, the controller completes the command with timeout error indication.

FIG. 7E is a flowchart illustrating a method 780 for when a completion is sent, according to certain embodiments. If the command has an entry in the “doorbell resource table”, then the entry is removed. Furthermore, if the command originated in a non-dedicated SQ (that is by a write to “gap”) the dynamic resource counter is incremented.

The method 780 begins at block 782. At block 782 a command completion is sent. At block 784, the controller determines whether the command is marked with “resource_used”. If the controller determines that the command is not marked with “resource_used”, then the method 780 returns to block 782. If the controller determines that the command is marked with “resource_used”, then the method 780 proceeds to block 786. At block 786, the controller removes the entry from “doorbell resource table” and increases DDBTR.

Normally, when a command is fetched, the current time is added as a timestamp for the command. If until or during execution the command times out, the controller reacts in accordance. The normal timeout depends on a system configuration (i.e., defined system timeout), for the short timeout commands there is a need to use a different timeout in addition to starting measurement from doorbell and not from fetching.

To complete the timed out of simple commands, the following formula can be used. If C+A>T, then the command times out where C is the command's time stamp, A is the defined system timeout, and T is the current time.

To keep using the same flow, then during command fetched the command's time stamp gets manipulated as follows: C=D-A+S where D is the doorbell time stamp and S is the short timeout.

If we put C into the original commands we obtain the following: (D-A+S)+A>T which simplifies to D+S>T. In other words, if the doorbell time stamp+the short timeout is greater than the current time, then the command has timed out.

The data storage device and hot communicate a number of supported resources that the controller has for tracking doorbells. The host uses the doorbells dynamically (i.e., dedicated SQ) or statically (i.e., doorbell stride). When a low timeout doorbell arrives, the controller stores the required information. As a result, the controller can cherry pick and timeout those specific commands.

Using the new approach allows the host (with device help) to provide a different and more accurate timeout for specific commands.

In one embodiment, a data storage device comprises: a memory device; and a controller coupled to the memory device, wherein the controller is configured to: communicate with a host device to inform the host device of a number of resources available for keeping doorbell times; handle the resources in a static manner, a dynamic manner, or a combination of static and dynamic, wherein the static manner is a dedicated submission queue (SQ), the dynamic manner is a hint during the doorbell. The dynamic manner comprises providing a DWORD gap between two doorbells. The controller is configured to mark and store a time of the doorbell for a doorbell written to a DROWD gap. The dedicated SQ has a preset timeout. The controller is configured to receive a number of resources allocated for the dedicated SQ from the host device. The controller is configured to receive an indication from the host device of a split of resources between the dynamic manner and the static manner. The controller is configured to create the dedicated queue in response to the host device indicating resources for the static manner. The controller is configured to determine whether a command received is a normal priority command, a dynamic manner priority command, or a static manner priority command. The controller is configured to track a number of available dynamic manner resources. The controller is configured to add a bit to a completion structure provided to the host device. In response to the bit being present, the controller is configured to increase a number of available resources for the dynamic manner. The controller is configured to create the dedicated submission queue in response to an instruction from the host device.

In another embodiment, a data storage device comprises: a memory device; and a controller coupled to the memory device, wherein the controller is configured to: receive a submission queue creation command; determine whether the submission queue is a high priority submission queue or a low timing submissions queue; determine whether a size of the submission queue is greater than a size of a static doorbell timing resource counter; mark the submission queue as low timing and high priority; decrease the static doorbell timing resource counter; and create the submission queue and send a completion message. The controller is further configured to receive a doorbell and determine whether the doorbell is a low timing or high priority doorbell. The controller is configured to determine whether the doorbell is in a gap location. The controller is configured to store a doorbell index and time. The controller is configured to mark a timestamp of a command as equal to a doorbell timestamp minus a system timeout plus an additional timeout.

In another embodiment, a data storage device comprises: means to store data; and a controller coupled to the means to store data, wherein the controller is configured to: compute a timeout of commands, wherein the computing comprises determining whether a command's timestamp plus a defined system timeout is greater than a current time; and timing out the command. During command fetching the command's timestamp equals a doorbell timestamp minus the defined system timeout plus an additional timeout. Timing out the command occurs because the doorbell timestamp plus the additional timeout is greater than the current time.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
communicate with a host device to inform the host device of a number of resources available for keeping doorbell times;
handle the resources in a static manner, a dynamic manner, or a combination of static and dynamic, wherein the static manner is a dedicated submission queue (SQ), the dynamic manner is a hint during the doorbell.

2. The data storage device of claim 1, wherein the dynamic manner comprises providing a DWORD gap between two doorbells.

3. The data storage device of claim 2, wherein the controller is configured to mark and store a time of the doorbell for a doorbell written to a DROWD gap.

4. The data storage device of claim 1, wherein the dedicated SQ has a preset timeout.

5. The data storage device of claim 4, wherein the controller is configured to receive a number of resources allocated for the dedicated SQ from the host device.

6. The data storage device of claim 1, wherein the controller is configured to receive an indication from the host device of a split of resources between the dynamic manner and the static manner.

7. The data storage device of claim 6, wherein the controller is configured to create the dedicated queue in response to the host device indicating resources for the static manner.

8. The data storage device of claim 7, wherein the controller is configured to determine whether a command received is a normal priority command, a dynamic manner priority command, or a static manner priority command.

9. The data storage device of claim 1, wherein the controller is configured to track a number of available dynamic manner resources.

10. The data storage device of claim 1, wherein the controller is configured to add a bit to a completion structure provided to the host device.

11. The data storage device of claim 10, wherein in response to the bit being present, the controller is configured to increase a number of available resources for the dynamic manner.

12. The data storage device of claim 1, wherein the controller is configured to create the dedicated submission queue in response to an instruction from the host device.

13. A data storage device, comprising:
a memory device; and
a controller coupled to the memory device, wherein the controller is configured to:
receive a submission queue creation command;
determine whether the submission queue is a high priority submission queue or a low timing submissions queue;
determine whether a size of the submission queue is greater than a size of a static doorbell timing resource counter;
mark the submission queue as low timing and high priority;
decrease the static doorbell timing resource counter; and
create the submission queue and send a completion message.

14. The data storage device of claim 13, wherein the controller is further configured to receive a doorbell and determine whether the doorbell is a low timing or high priority doorbell.

15. The data storage device of claim 13, wherein the controller is configured to determine whether the doorbell is in a gap location.

16. The data storage device of claim 13, wherein the controller is configured to store a doorbell index and time.

17. The data storage device of claim 13, wherein the controller is configured to mark a timestamp of a command as equal to a doorbell timestamp minus a system timeout plus an additional timeout.

18. A data storage device, comprising:
means to store data; and
a controller coupled to the means to store data, wherein the controller is configured to:
compute a timeout of commands, wherein the computing comprises
determining whether a command's timestamp plus a defined system timeout is greater than a current time; and
timing out the command.

19. The data storage device of claim 18, wherein during command fetching the command's timestamp equals a doorbell timestamp minus the defined system timeout plus an additional timeout.

20. The data storage device of claim 19, wherein timing out the command occurs because the doorbell timestamp plus the additional timeout is greater than the current time.
